(19) United States
(12) Patent Application Publication
(10) Pub. No.: US 2013/0118991 A1
(43) Pub. Date: May 16, 2013

(54) PROCESS AND APPARATUS FOR CONTROLLING A FILTRATION PLANT

(71) Applicants: Andreas Lekscha, Nuemberg (DE); Bernd Zehentbauer, Erlangen (DE)

(72) Inventors: Andreas Lekscha, Nuemberg (DE); Bernd Zehentbauer, Erlangen (DE)

(21) Appl. No.: 13/811,799

(22) PCT Filed: Jun. 14, 2011
(86) PCT No.: PCT/EP11/59843

§ 371 Date: Jan. 23, 2013

(30) Foreign Application Priority Data
Jul. 27, 2010 (EP) 10170867.5

(51) Int. Cl. B01D 33/80

(52) U.S. Cl. CPC B01D 33/804
USPC 210/740; 210/739; 210/741; 210/742; 210/96.1; 210/85; 210/744

(57) ABSTRACT

A process and an apparatus are provided for controlling a filtration plant having at least one vacuum filter, at least one vacuum pump and at least one filter tank, by which a medium that is to be filtered and that includes solid particles and liquid is separated into a concentrate including predominantly solid particles and a filtrate comprising predominantly liquid. The method may include: determining at least one first parameter of the filtration plant in the form of a residual moisture content of the concentrate and/or of a density of the filtrate as a function of time or a second parameter of the filtration plant, forming a derivative of the at least one first parameter after the time or the second parameter as at least one first characteristic, determining the sign of the at least one first characteristic, and controlling the filtration plant as a function of the determined sign.

### CROSS-REFERENCE TO RELATED APPLICATIONS

This application is a U.S. National Stage Application of International Application No. PCT/EP2011/059843 filed Jun. 14, 2011, which designates the United States of America, and claims priority to EP Patent Application No. 10170867.5 filed Jul. 27, 2010 The contents of which are hereby incorporated by reference in their entirety.

### TECHNICAL FIELD

The disclosure relates to a process and an apparatus for controlling (e.g., controlling and/or regulating) a filtration plant comprising at least one vacuum filter, at least one vacuum pump and at least one vacuum tank, wherein a medium which is to be filtered and comprises solid particles and liquid is separated by means of the filtration plant into a concentrate comprising predominantly solid particles and a filtrate comprising predominantly liquid.

### BACKGROUND

The filtration is a mechanical process for separating a medium comprising solid and a fluid. The end product of the filtration process is a concentrate or a so-called filter cake that is retained on a filter.

In the mining industry, filtration is the most important process for dewatering a medium or a suspension of solid and liquid, such as e.g. a sludge comprising water and rock particles, in order to produce an end product in the form of a moist concentrate or a filter cake. The residual moisture content of the concentrate or filter cake after the filtration should be as low as possible here, and represents an important quality criterion.

Filtration plants are divided according to the design of the filter that is used. There are two designs of filters in this case, and correspondingly two types of plants that are used in the mining industry, in particular the ore dressing industry. These are pressure filtration plants and vacuum filtration plants.

In this case, a vacuum filtration plant comprises a number of vacuum filters having in particular the form of rotating vacuum disc filters, vacuum band filters or vacuum drum filters, which are so arranged as to be partially immersed in a vacuum tank containing a medium that is to be filtered.

The filtration is a very resource-intensive and therefore cost-intensive process which is difficult to automate due to various factors. In particular, the process of vacuum filtration is very energy-intensive due to the required use of vacuum pumps.

In order continuously to achieve a desired residual moisture content in the end product or filter cake, given a predetermined constant flow rate of medium that must be filtered, filtration plants are often overdimensioned in their design. However, this increases the investment costs and operating costs.

One problem relating to the automation of the filtration process derives in particular from the process being affected by a varying or fluctuating moisture content of the medium that is to be filtered.

The vacuum filters of a vacuum filter plant are usually switched, operated, and automatically controlled in blocks, i.e. in parallel. According to a conventional method for automatically controlling a block of vacuum filters, a rotational speed of each individual vacuum filter and a consumption by each individual filter of a medium that is to be filtered are regulated as a function of the overall consumption per block of a medium that is to be filtered. The number of vacuum filters in operation, and a fill-level of medium in a vacuum tank from which each individual vacuum filter is supplied with medium that is to be filtered, are taken into consideration for corrective purposes during the regulation. However, this procedure does not take into consideration changes in the moisture content of the medium that is to be filtered or of the end product, nor does it take into consideration losses of solid in the filtrate, and it is therefore not sufficiently effective.

Further processes already in use for the purpose of automatically controlling a filtration plant are based on a determination of characteristics that characterize the filtration process, determination of a value of the derivative of one or more characteristics, and regulation of the process as a function of said value of the derivative(s). As described above, the control of a disc speed, band speed or drum speed of the vacuum filter in this case is effected as a function of the total load on the filtration plant and a fill-level in the vacuum tank of a medium that is to be filtered. A value of the derivative of the fill-level is formed according to the time, taking into consideration the number of vacuum filters in operation, the filter cake density that is achieved and the filtrate density of the filtrate that is formed. This procedure has the disadvantage that a minimal residual moisture content in the concentrate or filter cake cannot be achieved using a minimum of energy for the operation of the filtration plant.

Fuzzy logic or resource-intensive statistical models are also used to continuously calculate new adjustment parameters for the filtration plant on the basis of the moisture content (which changes continuously in practice) of the medium that is to be filtered, wherein the flow rate of medium drops, the energy requirement increases and the quality of the end product is reduced. This existing control is therefore resource-intensive yet does not produce optimal results.

U.S. Pat. No. 3,960,726 describes a filtration plant comprising a vacuum filter, wherein provision is made for regulating the fill-level in a vacuum tank and the rotational speed of the vacuum filter.

U.S. Pat. No. 3,672,067 describes a process for the steam drying of a filter cake, wherein during the formation of the filter cake provision is made for regulating the vacuum in a vacuum filter that rotates at a constant rotational speed.

U.S. Pat. No. 3,744,543 likewise discloses a process for the steam drying of a filter cake, wherein during the formation of the filter cake provision is made for regulating the vacuum and the rotational speed of the vacuum filter.

The unexamined German application number 26 06 514 describes a process and an apparatus for dewatering a dust slurry mixture. In this case, the quantity of filter cakes formed is monitored and used to regulate the delivery rate from the filter.

SU 1604416 A describes an automatic control of a vacuum filter, wherein provision is made for monitoring the filter fabric. Provision is made for monitoring the moisture content of the filter cake, the density of the medium that is to be filtered, the filtrate discharge and the filtrate density.

SU 691156 A describes an automatic control of a vacuum disc filter, wherein the rotational speed of the disc filter is changed as a function of the moisture content of the filter cake.

SU 1713617 A1 discloses an automatic control of an industrial vacuum filter. In this case, provision is made for monitoring the density of the medium that is to be filtered, the weight of the filter cake and the filtrate, in order to maintain a constant moisture content of the filter cake.

SU 1713618 A1 describes an automatic control of vacuum filters, wherein a band filter speed is regulated as a function of the moisture content of the filter cake.

SU 1725971 A1 describes an automatic control for a dewatering process for a suspension in a vacuum filter, wherein the residual moisture content of the filter cake, the density of the suspension that is to be filtered, and the filter productivity are measured by means of sensors.

SU 601029 A1 describes a process for dewatering a suspension by means of a vacuum filter, wherein the density of the suspension that is to be dewatered, any addition of water, the rotational speed of the vacuum filter, the vacuum in the vacuum filter and steam consumption are monitored for the purpose of maintaining a constant moisture content in the filter cake.

SU 665930 A describes an automatic control of a separation process for separating a suspension in a vacuum filter, wherein the rotational speed of the vacuum filter is regulated as a function of the moisture content of the filter cake that is formed.

WO 99/15255 A1 describes a process and an apparatus for the continuous monitoring, control and operation of a rotary drum filter in real-time.

### SUMMARY

One embodiment provides a process for controlling and/or regulating a filtration plant comprising at least one vacuum filter, at least one vacuum pump and at least one vacuum tank, by means of which a medium to be filtered and comprising solid particles and liquid is separated into a concentrate containing predominantly solid particles and a filtrate containing predominantly liquid, comprising steps as follows: determining at least one first parameter of the filtration plant in the form of a residual moisture content of the concentrate and/or a density of the filtrate as a function of a time t or of at least one second parameter of the filtration plant, forming a derivative of the at least one first parameter, according to the time t or the at least one second parameter, as at least one first characteristic, determining the sign of the at least one first characteristic, and controlling and/or regulating the filtration plant as a function of the sign that has been determined.

In a further embodiment, the at least one second parameter is selected from the group comprising a density of the medium that is to be filtered, a pressure in the vacuum filter, a rotational speed of the vacuum filter, a temperature T in the region of the vacuum filter, a thickness of the concentrate, a maximal service life of a filter fabric of the vacuum filter, a specific filter throughput, and a fill-level in the vacuum tank.

In a further embodiment, at least one first parameter of the filtration plant in the form of the residual moisture content of the concentrate is determined over the time t, the first characteristic and its sign are determined from this, the density of the medium that is to be filtered is determined as a function of the time t, and a derivative of the density of the medium that is to be filtered as a function of the time t is formed as at least one second characteristic, wherein the density of the medium to be filtered is increased if the sign of both the first characteristic and the second characteristic is positive, and the density of the medium to be filtered is decreased if the sign of both the first characteristic and the second characteristic is negative.

In a further embodiment, at least one first parameter of the filtration plant in the form of the residual moisture content of the concentrate is determined as a function of a second parameter in the form of the pressure in the vacuum filter, the first characteristic or a further first characteristic and its sign are determined from this, and wherein a pump throughput of the at least one vacuum pump is increased if the sign of the first characteristic or the further first characteristic is positive and decreased if the sign is negative.

In a further embodiment, the concentrate that has formed on the filter fabric of the vacuum filter is subjected to steam and furthermore the temperature T in a steam space above the concentrate is measured and regulated by increasing or reducing a supplied quantity of steam.

In a further embodiment, at least one first parameter of the filtration plant in the form of the residual moisture content of the concentrate is determined as a function of the temperature T, the first characteristic or a further first characteristic and its sign are determined from this, and wherein the temperature T is increased if the sign of the first characteristic or the further first characteristic is positive and the temperature T is decreased if the sign is negative.

In a further embodiment, at least one first parameter of the filtration plant in the form of the residual moisture content of the concentrate is determined as a function of a second parameter in the form of the specific filter throughput, the first characteristic or a further first characteristic and its sign are determined from this, the residual moisture content of the concentrate is determined as a function of a thickness of the concentrate, a derivative of the residual moisture content according to the thickness is formed as at least one second characteristic, and wherein the rotational speed of the vacuum filter is increased if the sign of the first characteristic and the second characteristic is positive, and decreased if the sign of the first characteristic and the second characteristic is negative.

In a further embodiment, at least one first parameter of the filtration plant in the form of the residual moisture content of the concentrate is determined as a function of the time t and/or in the form of the density of the filtrate as a function of the time t, the and/or a further first characteristic and its sign are derived from this, and a signal for the replacement of the filter fabric of the at least one vacuum filter is output by the at least one computing unit if the and/or the further first characteristic has/have a positive sign and if a predetermined maximal service life of the filter fabric has been exceeded.

Another embodiment provides an apparatus for performing any of the processes described above, the apparatus comprising: a filtration plant for separating a medium that is to be filtered and comprises solid particles and liquid into a concentrate containing predominantly solid particles and a filtrate containing predominantly liquid, comprising at least one vacuum filter, at least one vacuum pump and at least one vacuum tank for holding a medium that is to be filtered; at least one first device for determining at least one first parameter of the filtration plant in the form of a residual moisture content of the concentrate and/or a density of the filtrate as a function of the time t or of the at least one second parameter; at least one computing unit for forming a derivative of the at least one first parameter, according to the time t or the least one second parameter, as at least one first characteristic, and for determining the sign of the at least one first characteristic; and at least one control and/or regulation unit, which is connected to the at least one computing unit, for controlling and/or regulating the filtration plant as a function of the sign that has been determined.

In a further embodiment, the filtration plant comprises at least one first metering device for metering a raw medium comprising liquid and solid particles, at least one second metering device for adding further liquid to the raw medium, and a first measuring device for capturing the density of the medium that is to be filtered and is formed from the raw medium and possibly the further liquid, and wherein the at least one control and/or regulation unit is so configured as to change the density of the medium in accordance with a specification of the at least one computing unit by means of controlling and/or regulating the at least one first metering device and/or the at least one second metering device.

In a further embodiment, the filtration plant comprises at least one third metering device for metering the medium into the vacuum tank and at least one third measuring device for determining the fill-level of medium in the vacuum tank, and wherein the at least one control and/or regulation unit is so configured as to change the fill-level of medium in the vacuum tank in accordance with a specification of the at least one computing unit by means of controlling and/or regulating the at least one third metering device.

In a further embodiment, the filtration plant features a second measuring device for capturing the pressure in the at least one vacuum filter, and wherein the at least one control and/or regulation unit is so configured as to change the pump throughput of the at least one vacuum pump in accordance with a specification of the at least one computing unit.

In a further embodiment, the filtration plant comprises at least one drive for the at least one vacuum filter and at least one rotational speed regulator for capturing and regulating the rotational speed of the at least one vacuum filter, and wherein the at least one control and/or regulation unit is so configured as to change the rotational speed in accordance with a specification of the at least one computing unit by means of controlling and/or regulating the at least one drive.

In a further embodiment, the filtration plant comprises at least one steam supply device for applying steam to the concentrate that has formed and a temperature measuring device for determining the temperature T in a steam space above the concentrate, and wherein the at least one control and/or regulation unit is so configured as to change the steam supply quantity in accordance with a specification of the at least one computing unit by means of controlling and/or regulating the at least one steam supply device.

In a further embodiment, the at least one computing unit comprises a signal output unit for outputting an optical and/or acoustic warning signal when a replacement of the filter fabric is necessary.

In a further embodiment, the filtration plant additionally comprises a fourth measuring device for determining a thickness of the concentrate that has formed.

### BRIEF DESCRIPTION OF THE DRAWINGS

Exemplary embodiments will be explained in more detail below on the basis of the schematic drawings, wherein:

FIG. 1 shows a diagram of the qualitative dependency of the residual moisture content of the concentrate on the density of the medium that is to be filtered;

FIG. 2 shows a diagram of the qualitative dependency of the density of the medium that is to be filtered on the time;

FIG. 3 shows a diagram of the qualitative dependency of the residual moisture content of the concentrate on the pressure in the vacuum filter;

FIG. 4 shows a diagram of the qualitative dependency of the residual moisture content of the concentrate on a temperature T in the region of a vacuum filter;

FIG. 5 shows a diagram of the qualitative dependency of the residual moisture content of the concentrate on a specific filter throughput;

FIG. 6 shows a diagram of the qualitative dependency of the residual moisture content of the concentrate on a thickness of the concentrate that is present on the filter fabric of a vacuum filter;

FIG. 7 shows a diagram of the qualitative dependency of the residual moisture content of the concentrate on a rotational speed of the vacuum filter;

FIG. 8 shows a diagram of the qualitative dependency of the residual moisture content of the concentrate on a service life of the filter fabric of the vacuum filter;

FIG. 9 shows a schematic illustration of an apparatus for performing a process according to one embodiment; and

FIG. 10 shows a detail from FIG. 1 in the region of the filtration plant.

### DETAILED DESCRIPTION

Certain embodiments of the present disclosure provide a process for controlling and/or regulating a filtration plant comprising at least one vacuum filter, whereby a largely constant minimal residual moisture content in the end product, concentrate or filter cake can be achieved using minimal energy.

In some embodiments, a process for controlling and/or regulating a filtration plant comprises at least one vacuum filter, at least one vacuum pump and at least one vacuum tank, by means of which a medium that is to be filtered and comprises solid particles and liquid is separated by means of the filtration plant into a concentrate comprising predominantly solid particles and a filtrate comprising predominantly liquid, the process comprising the following steps:
determining at least one first parameter of the filtration plant in the form of a residual moisture content of the concentrate and/or a density of the filtrate as a function of a time t or of at least one second parameter of the filtration plant,
forming a derivative of the at least one first parameter, according to the time t or the at least one second parameter, as at least one first characteristic,
determining the sign of the at least one first characteristic, and
controlling and/or regulating the filtration plant as a function of the sign that has been determined.

Other embodiments of the present disclosure provide an apparatus for performing the disclosed process, wherein the apparatus may comprise:
a filtration plant for separating a medium that is to be filtered and comprises solid particles and liquid into a concentrate comprising predominantly solid particles and a filtrate comprising predominantly liquid, comprising at least one vacuum filter, at least one vacuum pump and at least one vacuum tank for holding a medium that is to be filtered,
at least one first device for determining at least one first parameter of the filtration plant in the form of a residual moisture content of the concentrate and/or a density of the filtrate as a function of the time t or of the at least one second parameter,
at least one computing unit for forming a derivative of the at least one first parameter, according to the time t or the at least one second parameter, as at least one first characteristic, and for determining the sign of the at least one first characteristic, and
at least one control and/or regulation unit, connected to the at least one computing unit, for controlling and/or regulating the filtration plant as a function of the sign that has been determined.

The disclosed process and apparatus may provide an innovative means for operating a filtration plant comprising at least one vacuum filter, such that a concentrate or a filter cake having minimal residual moisture content can be produced continuously while consuming minimal energy.

The at least one second parameter for the process may be selected from the group comprising a density ζ of the medium that is to be filtered, a pressure p in the vacuum filter, a rotational speed n of the vacuum filter, a temperature T in the region of the vacuum filter, a thickness d of the concentrate, a maximal service life of a filter fabric of the vacuum filter, a specific filter throughput g, and a fill-level h in the vacuum tank of a medium that is to be filtered. However, other second parameters such as a pump throughput of the at least one vacuum pump, a density of the filtrate, etc. can also be selected, provided that they differ from the first parameter.

The density measurement of the medium that is to be filtered can take place in the vacuum tank or in a supply line that is provided for the medium to the vacuum tank.

A temperature measurement for determining a temperature T may take place in a gas space or steam space, which is in contact with the concentrate that has formed on the filter fabric of the vacuum filter, as soon as the concentrate emerges or appears from the medium that is to be filtered.

The specific filter throughput (e.g. in 1/min per m² of filter surface area) is specified by the quantity (of a medium that is to be filtered) which is processed per time unit relative to a specific surface area unit of the filter fabric. The quantity of medium that is processed per time unit can be calculated from a measurement of the fill-level in the vacuum tank over the time and the measurement of the quantity of medium that is supplied into the vacuum tank over the time, taking into consideration the actual surface area of filter fabric.

In a first control loop of the process, provision may be made for at least one first parameter of the filtration plant in the form of the residual moisture content of the concentrate to be determined over the time t, for the first characteristic and its sign to be determined from this, for the density of the medium that is to be filtered to be determined as a function of the time t, and for a derivative of the density of the medium that is filtered as a function of the time t to be formed as at least one second characteristic, wherein the density of the medium to be filtered is increased if the sign of both the first characteristic and the second characteristic is positive, and the density of the medium to be filtered is decreased if the sign of both the first characteristic and the second characteristic is negative.

For this purpose, the filtration plant of the apparatus may comprise at least one first metering device for metering a raw medium comprising liquid and solid particles and at least one second metering device for adding further liquid to the raw medium, and additionally comprises a first measuring device for capturing the density of the medium that is to be filtered, said medium comprising the raw medium and possibly the further liquid, wherein the at least one control and/or regulation unit is so configured as to change the density of the medium according to a specification of the at least one computing unit by means of controlling and/or regulating the at least one first metering device and/or the at least one second metering device.

As an alternative to or in combination with the first control loop, a second control loop may further provide for at least one first parameter of the filtration plant in the form of the residual moisture content of the concentrate to be determined as a function of a second parameter in the form of the pressure in the vacuum filter, for the first characteristic or a further first characteristic and its sign to be determined from this, and for a pump throughput of the at least one vacuum pump to be increased if the sign of the or further first characteristic is positive and reduced if said sign is negative.

For this purpose, the filtration plant of the apparatus may comprise a second measuring device for capturing the pressure in the at least one vacuum filter, wherein the at least one control and/or regulation unit is so configured as to change the pump throughput of the at least one vacuum pump in accordance with a specification of the at least one computing unit.

In an effective embodiment, the concentrate that has formed on the filter fabric of the vacuum filter is subjected to steam and furthermore the temperature T in a steam space above the concentrate is measured and regulated by increasing or reducing a supplied quantity of steam. The steam is sucked through the concentrate and the filter fabric, thereby pushing liquid out of the open pore space contained in the concentrate.

As an alternative to or in combination with the first and/or second control loop, a third control loop may further provide for at least one first parameter of the filtration plant in the form of the residual moisture content of the concentrate to be determined as a function of the temperature T, for the first characteristic or a further first characteristic and its sign to be determined from this, and for the temperature T to be increased if the sign of the first characteristic or the further first characteristic is positive and for the temperature T to be decreased if said sign is negative.

For this purpose, the filtration plant of the apparatus comprises in particular at least one steam supply device for applying steam to the concentrate that has formed, and additionally a temperature measuring device for determining the temperature T in a steam space above the concentrate, wherein the at least one control and/or regulation unit is so configured as to change the steam supply quantity in accordance with a specification of the at least one computing unit by means of controlling and/or regulating the at least one steam supply device.

As an alternative to or in combination with the first and/or second and/or third control loop, a fourth control loop may provide for at least one first parameter of the filtration plant in the form of the residual moisture content of the concentrate to be determined as a function of a second parameter in the form of the specific filter throughput, for the first characteristic or a further first characteristic and its sign to be determined from this, for a residual moisture content of the concentrate to then be determined as a function of a thickness of the concentrate, for a derivative of the residual moisture content according to the thickness to be formed as at least one second characteristic, and for the rotational speed of the vacuum filter to be increased if the sign of the first characteristic and the second characteristic is positive and decreased if the sign of the first characteristic and the second characteristic is negative.

For the purpose of determining the specific filter throughput, the filtration plant of the apparatus comprises at least one third metering device for metering the medium in the vacuum tank and at least one third measuring device for determining the fill-level of medium in the vacuum tank, wherein the at least one control and/or regulation unit is so configured as to change the fill-level of medium in the vacuum tank in accordance with a specification of the at least one computing unit by means of controlling and/or regulating the at least one third metering device.

For this purpose, the filtration plant of the apparatus further comprises at least one drive for the at least one vacuum filter and at least one rotational speed sensor for capturing the rotational speed of the at least one vacuum filter, wherein the at least one control and/or regulation unit is so configured as to change the rotational speed in accordance with a specification of the at least one computing unit by means of controlling and/or regulating the at least one drive.

As an alternative to or in combination with the first and/or second and/or third and/or fourth control loop, a fifth control loop may provide for at least one first parameter of the filtration plant in the form of the residual moisture content of the concentrate to be determined as a function of the time t, and/or in the form of the density of the filtrate as a function of the time t, for the and/or a further first characteristic and its sign to be determined from this, and for the at least one computing unit to output a signal for the replacement of the filter fabric of the at least one vacuum filter if the and/or the further first characteristic has/have a positive sign and if a predetermined maximal service life of the filter fabric has been exceeded.

For this purpose, the at least one computing unit may comprise a signal output unit for outputting an optical and/or acoustic warning signal when it is necessary to change the filter fabric. By virtue of the warning signal, the operating staff of the filtration plant can replace the filter fabric that has meanwhile become ineffective with a new filter fabric that functions correctly. In particular, the maximal service life of the filter fabric is stored on the at least one computing unit.

In a further effective embodiment, the filtration plant of the apparatus further comprises a fourth measuring device for determining a thickness d of the concentrate that has formed.

In one embodiment of the process, provision is made for using at least two of the five control loops concurrently, and in particular for using all five control loops concurrently. This results in homogenization of the filtration process and allows particularly effective and energy-saving filtration of the medium while maintaining a constant minimal residual moisture content of the concentrate.

If required when two or more control loops are used concurrently, the at least one computing unit is so configured as to grant a higher status to one or more control loops, i.e. to a subset of control loops from the set of available control loops. This may be applicable if vibration or overloading of the filtration plant occurs. In this way, the control loops according to which the filtration plant should be operated in such a case can be defined in the at least one computing unit by the operator of the filtration plant. Other control loops are given lower priority or even briefly ignored in favor of those having a higher status, until the filtration plant has returned to a defined state. The operator of the plant will usually regulate according to the residual moisture content of the concentrate here, or strive for a minimal overall energy consumption of the filtration plant, and will define in advance those control loops that are to assume responsibility correspondingly.

The disclosed process and the apparatus may be used, for example, for the filtration of ore sludge.

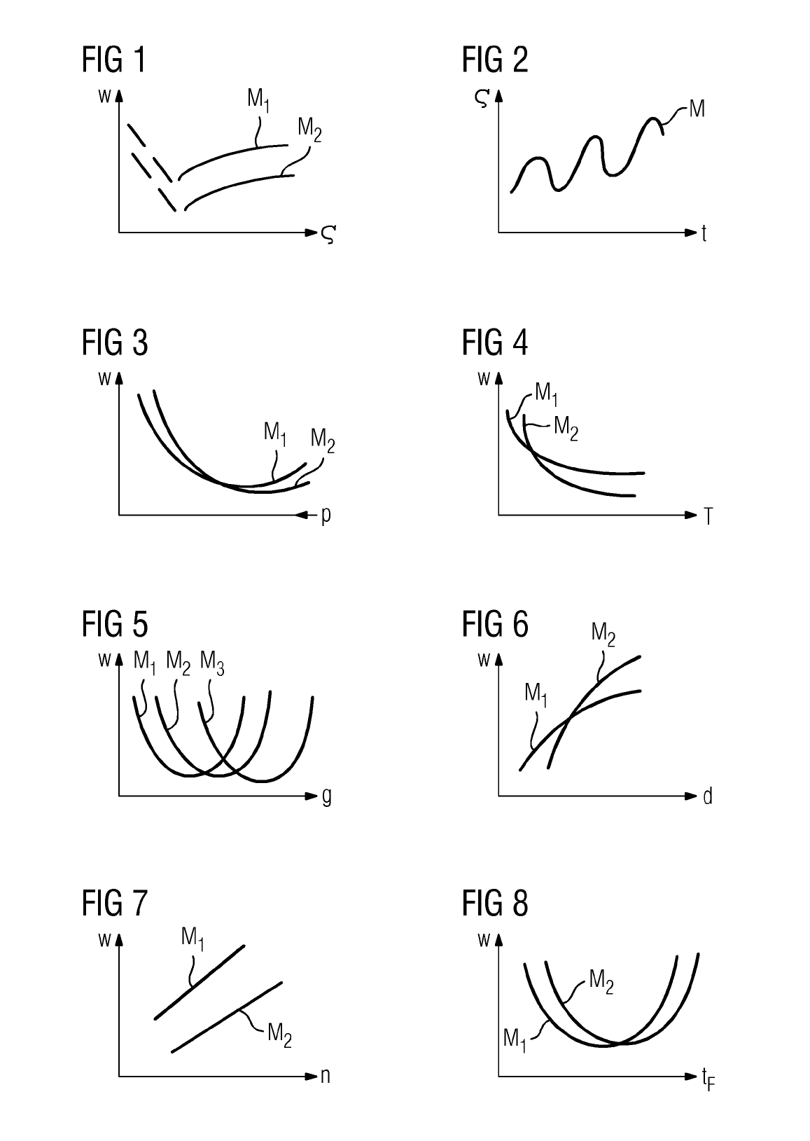

FIG. 1 shows a diagram of the qualitative dependency of the residual moisture content w of the concentrate on the density ζ for two different media M₁, M₂ that are to be filtered. The medium M₁, M₂ is in particular a suspension, in particular an ore sludge comprising rock particles and water. It is evident that, with an increasing density of the medium M₁, M₂ that is to be filtered, the residual moisture content of the concentrate first drops but then rises again. It may therefore be preferable to work in a region before or at the reversal point of the curve, in order to minimize the residual moisture content w.

FIG. 2 shows a diagram of the qualitative dependency of the density ζ of a medium M that is to be filtered over the time t. It is evident that the density ζ fluctuates perceptibly and therefore influences the residual moisture content w that can be achieved in the concentrate (cf. FIG. 1).

FIG. 3 shows a diagram of the qualitative dependency of the residual moisture content w of a concentrate on the vacuum or pressure in the vacuum filter for different media M₁, M₂ that are to be filtered. The residual moisture content w in the concentrate rises as the pressure p increases or the vacuum drops.

FIG. 4 shows a diagram of the qualitative dependency of the residual moisture content w of a concentrate on a temperature T in the region of a vacuum filter. A temperature measurement for determining a temperature T may take place in a gas space or steam space, which is in contact with the concentrate that has formed on the filter fabric of a vacuum filter, as soon as the concentrate emerges or appears from the medium M₁, M₂ that is to be filtered.

FIG. 5 shows a diagram of the qualitative dependency of the residual moisture content w of a concentrate on a specific filter throughput g for three different media M₁, M₂, M₃. As the filter throughput increases, the residual moisture content w reaches a minimum and then rises again. It may therefore be preferable to adjust the specific filter throughput g such that the residual moisture content w is located in the region of the minimum.

FIG. 6 shows a diagram of the qualitative dependency of the residual moisture content w of the concentrate on a thickness d of the concentrate that is present on the filter fabric of a vacuum filter for different media M₁, M₂. In this case, the residual moisture content w in the concentrate or filter cake that has formed rises as the thickness of the concentrate increases.

FIG. 7 shows a diagram of the qualitative dependency of the residual moisture content w of the concentrate on a rotational speed of the vacuum filter for different media M₁, M₂. The faster a vacuum filter rotates, the less time is available for dewatering the concentrate. Therefore the residual moisture content w of the concentrate increases as the rotational speed n increases.

FIG. 8 shows a diagram of the qualitative dependency of the residual moisture content w of the concentrate on a service life t_{F} of the filter fabric of a vacuum filter for different media M₁, M₂. A newly installed filter fabric causes a drop in the residual moisture content w of the concentrate that has formed. A minimum is achieved at a certain service life t_{F}, after which the residual moisture content w in the concentrate increases again.

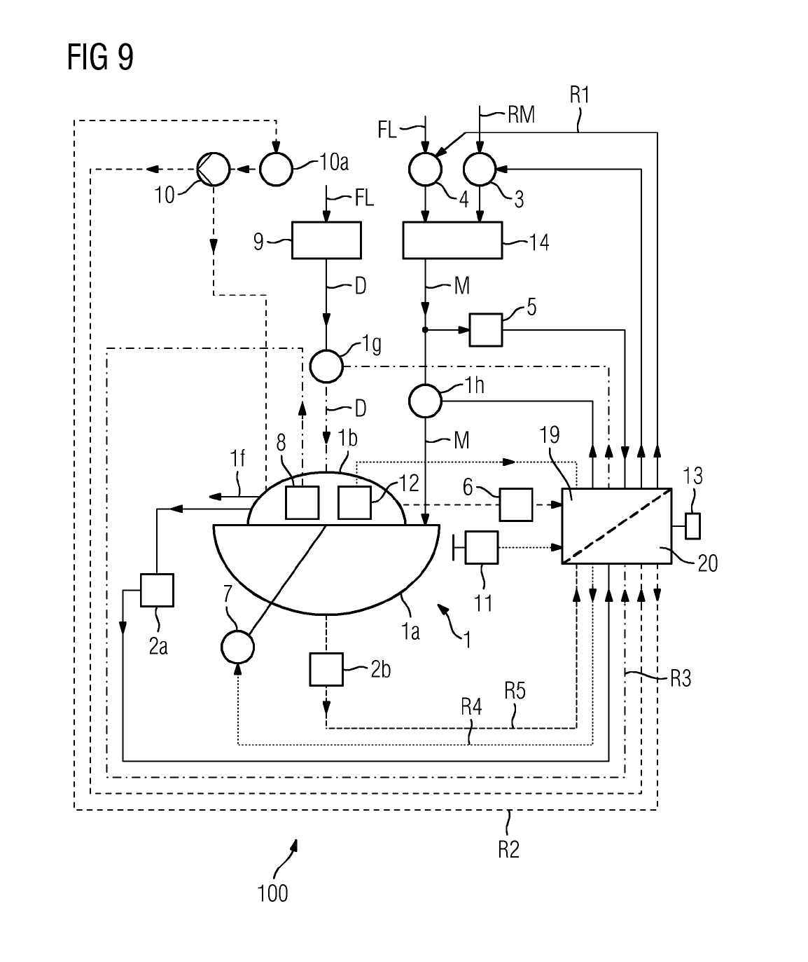

FIG. 9 shows a schematic illustration of an apparatus 100 for performing a process according to one embodiment, comprising a total of five possible control loops R1, R2, R3, R4, R5. Alternatively, just one of the control loops or a combination of two to four of the control loops R1, R2, R3, R4, R5 can also be provided here.

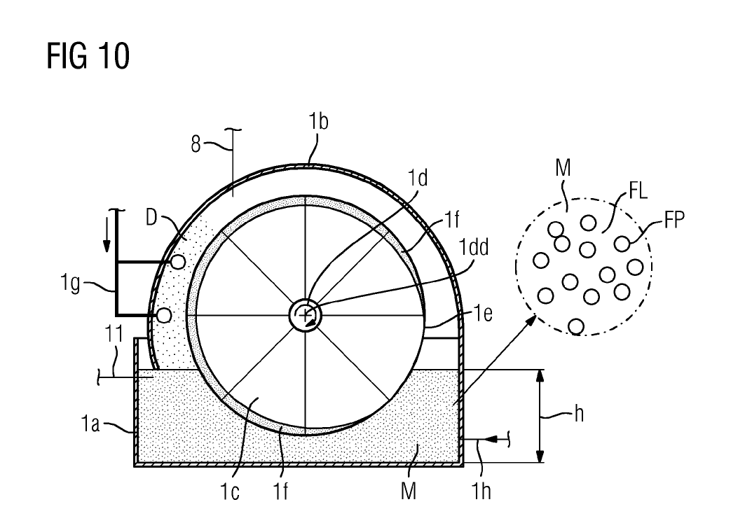

The apparatus 100 comprises a filtration plant 1 for separating a medium M that is to be filtered (cf. also FIG. 10) and comprises solid particles FP and liquid FL into a concentrate 1f or filter cake comprising predominantly solid particles FP and a filtrate comprising predominantly liquid FL. The medium can be in particular a suspension, in particular an ore sludge comprising rock particles as solid particles and water as a liquid.

The filtration plant 1 here (cf. also FIG. 10) comprises a vacuum tank 1a for holding a medium M that is to be filtered, over which a filter tent 1b extends, and a vacuum filter 1c in the form of a drum filter which is arranged within the space that is enclosed by the vacuum tank 1a and the filter tent 1b. FIG. 10 shows a side view of the drum filter. The drum filter has a plurality of chambers and is covered at its circumference by a filter fabric 1e.

The filtration plant 1 further comprises a vacuum pump 10 with regulator 10a for generating an underpressure in the chambers of the drum filter or on a side of the filter fabric 1e that faces away from the medium M. During the filtration process, the vacuum filter 1c rotates about an axis of rotation 1dd, driven by a drive 1d that is indicated merely schematically in FIG. 10 by means of the arrow. The vacuum filter 1c is partially immersed in the medium M, liquid FL being sucked through the filter fabric 1e as a result of the underpressure in the chambers. In this way, the concentrate 1f or the filter cake forms on the filter fabric 1e. As soon as the concentrate 1f surfaces from the medium M as a result of the rotational movement of the drum filter, it is then situated in a steam space that extends between the filter tent 1b and the filter fabric 1e. Steam D is introduced into the steam space by means of a steam supply device 1g and is sucked through the concentrate 1f. In this way, any quantity of liquid that is still contained in the pore space of the concentrate 1f is expelled in the direction of the chambers or the axis of rotation 1dd of the vacuum filter 1c, and the concentrate 1f is drained of any residual moisture content w.

In order to allow the fill-level h of medium M in the vacuum tank 1a to be maintained or changed, provision is made for a third metering device 1h via which the medium M is metered into the vacuum tank 1a.

The filtrate arriving in the chambers is carried away in the region of the axis of rotation 1dd, while the concentrate 1f is detached from the filter fabric 1e and removed as an end product before the filter fabric 1e is immersed in the medium M again. For the sake of clarity, this is not shown in detail in FIG. 10. The concentrate 1f is detached from the filter fabric 1e e.g. by means of a scraper, air blown onto the filter fabric 1e, etc.

The apparatus 100 further comprises a first device 2a for determining a first parameter of the filtration plant in the form of a residual moisture content w of the concentrate 1f and a further first device 2b for determining a further first parameter of the filtration plant in the form of a density of the filtrate as a function of the time t or a second parameter of the filtration plant 1.

The apparatus further comprises a computing unit 19 for forming a derivative of the first parameter according to the time t or the second parameter, thus forming at least one first characteristic, and for determining the sign of the first characteristic(s). The computing unit 19 is connected to a control and/or regulation unit 20 of the apparatus 100 for controlling and/or regulating the filtration plant 1 as a function of the sign that has been determined. The computing unit 19 is integrated in the control and regulation unit 20 in this example, but can be arranged separately in order to allow remote monitoring of the apparatus 100, for example.

The filtration plant 1 further comprises a first metering device 3 for metering a raw medium RM comprising liquid FL and solid particles FP, and a second metering device 4 for adding further liquid FL to the raw medium RM. Homogenization of raw medium and further liquid takes place in a mixing container 14. The filtration plant 1 further comprises a first measuring device 5 for capturing the density ζ of the medium M that is formed from the raw medium RM and possibly further liquid FL.

The control and/or regulation unit 20 is so configured as to change the density ζ of the medium M in accordance with a specification of the at least one computing unit 19 by means of controlling and/or regulating the first metering device 3 and/or the second metering device 4.

In addition to the third metering device 1h for metering of the medium M into the vacuum tank 1a, the filtration plant 1 comprises a third measuring device 11 for determining the fill-level h of medium M in the vacuum tank 1a. The control and/or regulation unit 20 is so configured as to change the fill-level h of medium M in the vacuum tank 1c in accordance with a specification of the at least one computing unit 19 by means of controlling and/or regulating the at least one third metering device 1h.

The filtration plant 1 further comprises a second measuring device 6 for capturing of the pressure p in the at least one vacuum filter 1c. The control and/or regulation unit 20 is so configured as to change the pump throughput of the at least one vacuum pump 10 in accordance with a specification of the at least one computing unit 19.

In addition to the drive 1d for the vacuum filter 1c, the filtration plant 1 comprises a rotational speed regulator 7 for regulating and capturing the rotational speed n of the at least one vacuum filter 1c, wherein the at least one control and/or regulation unit 20 is so configured as to change the rotational speed n in accordance with a specification of the computing unit 19 by means of controlling and/or regulating the drive 1d.

In addition to the steam supply device 1g for applying steam to the concentrate 1f that has formed, the filtration plant 1 further comprises a temperature measuring device 8 for determining the temperature T in the steam space above the concentrate 1f. The control and/or regulation unit 20 is so configured as to change the steam supply quantity in accordance with a specification of the at least one computing unit 19 by means of controlling and/or regulating the steam supply device 1g.

The computing unit 19 has a signal output unit 13 for outputting an optical and/or acoustic warning signal when replacement of the filter fabric 1e is necessary.

The filtration plant 1 can further comprise a fourth measuring device 12 for determining a thickness d of the concentrate 1f that has formed.

In a first control loop R1 (represented by continuous lines) of the apparatus 100 during the filtration mode, a first parameter of the filtration plant 1 in the form of the residual moisture content w of the concentrate 1f is determined over the time t by the first device 2a. The first characteristic and its sign are determined from this by means of the computing unit 19. Furthermore, the density ζ of the medium M that is to be filtered is determined as a function of the time t by the first measuring device 5, and a derivative of the density ζ of the medium M that is to be filtered as a function of the time t is formed as at least one second characteristic by means of the computing unit 19. The density ζ of the medium M to be filtered is increased if the sign of both the first characteristic and the second characteristic is positive, and the density ζ of the medium M to be filtered is decreased if the sign of both the first characteristic and the second characteristic is negative, in that the metering quantities for liquid FL and raw medium RM are regulated correspondingly by the first metering device 3 and the second metering device 4 by means of the control and/or regulation unit 20.

In a second control loop R2 (partly represented by broken lines) of the apparatus 100 during the filtration mode, a first parameter of the filtration plant 1 in the form of the residual moisture content w of the concentrate 1f is determined by the first device 2a as a function of a second parameter in the form of the pressure p in the vacuum filter 1c, said pressure p being captured continuously by means of the second measuring device 6. A further first characteristic and its sign are determined from this by means of the computing unit 19. A pump throughput of the at least one vacuum pump 10 is increased via the regulator 10a if the sign of the further first characteristic is positive and decreased if the sign is negative. The actual value of the pump throughput is reported back to the control and/or regulation unit 20.

In a third control loop R3 (partly represented by dotted lines) of the apparatus 100, a first parameter of the filtration plant 1 in the form of the residual moisture content w of the concentrate 1f is determined by means of the first device 2a as a function of the temperature T, which is captured via the temperature measuring device 8. A further first characteristic and its sign are determined from this by means of the computing unit 19. The temperature T is increased if the sign of the further first characteristic is positive and decreased if the sign is negative, by regulating the steam supply to the concentrate 1f via the steam supply device 1g.

In a fourth control loop R4 (partly represented by strike-through lines) of the apparatus 100, a first parameter of the filtration plant in the form of the residual moisture content w of the concentrate 1f is determined by means of the first device 2a as a function of a second parameter in the form of the specific filter throughput g. In order to determine the specific filter throughput g (e.g. in 1/min per m² of filter surface area), the quantity (of a medium M that is to be filtered) which is processed per time unit relative to the surface area of the filter fabric 1e is determined. The quantity of medium M that is processed per time unit is calculated by means of the computing unit 19 from a measurement by the third measuring device 11 of the fill-level h in the vacuum tank over the time t, and the measurement by the first measuring device 5 of the quantity of medium M that is supplied into the vacuum tank 1a over the time t, taking into consideration the actual surface area of filter fabric 1e. A further first characteristic and its sign are determined from this. The residual moisture content w of the concentrate 1f is then determined as a function of a thickness d of the concentrate. The thickness d of the concentrate 1f is captured by means of a fourth measuring device 12 of the filtration plant 1 and sent to the computing unit 19, and a derivative of the residual moisture content w according to the thickness d is formed as a second characteristic. The rotational speed n of the vacuum filter 1c is increased at the drive 1d by means of the rotational speed regulator 7 if the sign of the first characteristic and the second characteristic is positive, and decreased if the sign of the first characteristic and the second characteristic is negative.

In a fifth control loop R5 (partly represented by wavy lines) of the apparatus 100, a first parameter of the filtration plant in the form of the residual moisture content w of the concentrate 1f is determined by means of the first device 2a as a function of the time t, and in the form of the density of the filtrate by means of the further first device 2b as a function of the time t. Further first characteristics and their signs are determined from this in the computing unit 19. A signal for the replacement of the filter fabric 1e of the vacuum filter 1c is then output by the computing unit 19 if at least one of these further first characteristics has a positive sign and if a predetermined maximal service life T_{Fmax} of the filter fabric 1e has been exceeded. The signal can be an optical and/or acoustic warning signal in this case, which is output by the signal output unit 13 of the computing unit 19 and prompts the operating staff to replace the filter fabric 1e.

It is obvious to a person skilled in the art that the five exemplary control loops shown here can be used alone or in any desired combination, in order to reduce or minimize the residual moisture content w in the concentrate that has formed. It is also obvious to a person skilled in the art that other types of vacuum filter can readily be used for the inventive process or the inventive apparatus.

What is claimed is:

1. A process for controlling a filtration plant comprising at least one vacuum filter, at least one vacuum pump, and at least one vacuum tank configured to process a medium to be filtered and comprising solid particles and liquid to separate the medium into a concentrate containing predominantly solid particles and a filtrate containing predominantly liquid, the method comprising:
determining at least one first parameter of the filtration plant including at least one of (a) a residual moisture content of the concentrate as a function of a time t or as a function of at least one second parameter of the filtration plant and (b) a density of the filtrate as a function of a the time t or as a function of at least one second parameter of the filtration plant,
calculating at least one first characteristic comprising a derivative of the at least one first parameter, according to the time t or the at least one second parameter,
determining a sign of the at least one first characteristic, and
controlling the filtration plant as a function of the determined sign of the at least one first characteristic.

2. The process as claimed in claim 1, wherein the at least one second parameter is selected from the group consisting of:
a density of the medium that is to be filtered,
a pressure in the at least one vacuum filter,
a rotational speed of the at least one vacuum filter,
a temperature T in a region of the at least one vacuum filter,
a thickness of the concentrate,
a maximal service life of a filter fabric of the at least one vacuum filter,
a specific filter throughput, and
a fill-level in the at least one vacuum tank.

3. The process of claim 2,
comprising determining as a first pa rameter of the filtration plant the residual moisture content of the concentrate as a function of the time t,
determining the first characteristic and its sign based on the at least one first, parameter,
determining a density of the medium to be filtered as a function of the time t,
calculating a second characteristic comprising the derivative of the density of the medium to be filtered as a function of the time t,
increasing the density of the medium to be filtered the signs of both the first characteristic and the second characteristic are positive, and
decreasing the density of the medium to be filtered if the signs of both the first characteristic and the second characteristic are negative.

4. The process of claim 2, comprising:
wherein a first parameter of the filtration plant is the residual moisture content of the concentrate as a function of a second parameter in the form of the pressure in the vacuum filter,
determining the first characteristic or a further first characteristic and its sign based on the determined first parameter, and
increasing a pump throughput of the at least one vacuum pump if the determined sign is positive, and
decreasing the pump throughput of the at least one vacuum pump if the determined sign is negative.

5. The process of claim 2, comprising subjecting the concentrate that has formed on the filter fabric of the at least one vacuum filter to steam, and
measuring a temperature T in a steam space above the concentrate and regulating the temperature by increasing or reducing a supplied quantity of steam.

6. The process of claim 5, comprising:
wherein a first parameter of the filtration plant is the residual moisture content of the concentrate as a function of the temperature T,
determining the first characteristic or a further first characteristic and its sign based on the determined first parameter,
increasing the temperature if the determined sign is positive, and
decreasing the temperature if the determined sign is negative.

7. The process of claim 2, comprising:
wherein a first parameter of the filtration plant is the residual moisture content of the concentrate as a function of a second parameter in the form of the specific filter throughput,
determining first characteristic or a further first characteristic and its sign based on the determined, first parameter,
determining the residual moisture content of the concentrate as a function of a thickness of the concentrate,
calculating as a second characteristic a derivative of the residual moisture content based on the thickness of the concentrate,
increasing a rotational speed of the at least one vacuum filter if the signs of the first characteristic and the second characteristic are positive, and
decreasing the rotational speed of the at least one vacuum, filter if the signs of the first characteristic and the second characteristic are negative.

8. The process of claim 2, comprising:
wherein a first parameter of the filtration plant is either (a) the residual moisture content of the concentrate is determined as a function of the time t and/or (b) the density of the filtrate as a function of the time t,
determining the first characteristic or a further first characteristic and its sign based on the first parameter, and
outputting a signal for the replacement of the filter fabric of the at least one vacuum filter by the at least one computing unit if (a) the first characteristic or the further first characteristic has a positive sign and a predetermined maximal service life of the filter fabric has been exceeded.

9. An apparatus for controlling a filtration plant comprising at least one vacuum filter, at least one vacuum pump and at least one vacuum tank, by means of which a medium to be filtered, and comprising solid particles and liquid is separated into a concentrate containing predominantly solid particles and a filtrate containing predominantly liquid, the apparatus comprising:
a filtration plant for separating a medium that is to be filtered and comprises solid particles and liquid into a concentrate containing predominantly solid particles and a filtrate containing predominantly liquid, the filtration plant comprising at least one vacuum filter, at least one vacuum pump, and at least one vacuum tank for holding a medium to be filtered,
at least one first device for determining at least one first parameter of the filtration plant, the at least one first parameter comprising at least one of (a) a residual moisture content of the concentrate as a function of a time t or as a function of at least one second parameter and (b) a density of the filtrate as a function of the time t or as a function of the at least one second parameter,
at least one computing unit for calculating as at least one first characteristic a derivative of the at least one first parameter as a function of the time t or the least one second parameter, and for determining a sign of the at least one first characteristic, and
at least one control unit coupled to the at least one computing unit and configured to control the filtration plant as a function of the determined sign.

10. The apparatus of claim 9, wherein the filtration plant comprises:
at least one first metering device for metering a raw medium comprising liquid and solid particles,
at least one second metering device for adding further liquid to the raw medium, and
a first measuring device for capturing the density of the medium to be filtered, and
wherein the at least one control unit is configured as to change the density of the medium based on a specification of the at least one computing unit by controlling at least one of the at least one first metering device and the at least one second metering device.

11. The apparatus of claim 9, wherein the filtration plant comprises:
at least one third metering device for metering the medium into the vacuum tank, and
at least one third measuring device for determining the fill-level of medium in the vacuum tank, and
wherein the at least one control unit is configured to change the fill-level of medium in the vacuum tank based on a specification of the at least one computing unit by controlling the at least one third metering device.

12. The apparatus of claim 9, wherein:
the filtration plant features comprises a second measuring device for capturing the pressure in the at least one vacuum filter, and
the at least one control unit is configured to change the pump throughput of the at least one vacuum pump based on a specification of the at least one computing unit.

13. The apparatus of claim 9, wherein the filtration plant comprises:
at least one drive for the at least one vacuum filter, and
at least one rotational speed regulator for capturing and regulating the rotational speed of the at least one vacuum filter, and
wherein the at least one control and/or regulation unit is configured to change the rotational speed* based on a specification of the at least one computing unit by controlling the at least one drive.

14. The apparatus of claim 9, wherein the filtration plant comprises:
at least one steam supply device for applying steam to the concentrate that has formed, and
a temperature measuring device for determining the temperature T in a steam space above the concentrate, and
wherein the at least one control unit is configured to change the steam supply quantity based on a specification of the at least one computing unit by controlling the at least one steam supply device.

15. The apparatus of claim 9, wherein the at least one computing unit comprises a signal output unit for outputting at least one of an optical warning signal and an acoustic warning signal regarding a replacement of the filter fabric.

16. The apparatus of claim 9, wherein the filtration plant further comprises a fourth measuring device for determining a thickness of the concentrate that has formed.
